(19) United States
(12) Patent Application Publication
(10) Pub. No.: US 2017/0159929 A1
(43) Pub. Date: Jun. 8, 2017

(54) USB multi-functional LED clip lamp

(71) Applicant: Dongguan City General Success Industrial Co.. LTD., Dongguan (CN)

(72) Inventor: Ming Li, Dongguan (CN)

(21) Appl. No.: 14/961,897

(22) Filed: Dec. 8, 2015

(51) Int. Cl. F21V 33/00; F21V 21/32; H01R 24/60; F21V 1/00; F21V 29/74; F21V 21/088; F21V 23/04

(52) U.S. Cl. CPC F21V 33/0024; F21V 21/088; F21V 21/32; F21V 23/0485; F21V 1/00; F21V 29/74; H01R 24/60

(57) ABSTRACT

The present invention relates to a USB multi-functional LED clip lamp belonging to a technical field of lighting equipments, including: a lightshade, an LED light source, a supporting column and a base, wherein the LED light source is mounted inside the lightshade; the base comprises a clip for clamping, and a connecting box at a top of the clip; a main control circuit board comprises a USB module; wherein an interface module is fixed inside the connecting box, which comprises a USB interface for electrically connecting the USB module, and a power socket. The present invention has a simple while reasonable structure, which is able to be fixed by directly fixing the clip at a table edge or other positions which is able to be clamped, and stability thereof is high. Furthermore, the interface module is directly fixed on the connecting box, so as to be easily assembled.

### BACKGROUND OF THE PRESENT INVENTION

Field of Invention

The present invention relates to a technical field of lighting equipments, and more particularly to a USB multi-functional LED clip lamp.

Description of Related Arts

Lamp is a household appliance in people daily lives for lighting, which is necessary for study and work at night. The lamp is generally divided into two types: standing one and clip one. Working principles thereof mainly comprise concentrating light within a small area and focusing the light, so as to be conducive to work and study. A common structure of the lamp comprises a holder, a supporter and a lampshade. Usually, incandescent or energy-saving bulbs are used, but the incandescent bulbs are not energy saving, and the energy-saving bulbs save less energy than LED does. Furthermore, the energy-saving bulbs are short-lived, which requires frequent replacement. During the replacement, an electric shock may be caused due to forgetting turn off the power or improper operation, which can be too severe to threaten lives.

Lamp, power strip and USB interface are common items at home. If the three items are integrated, a lot of resources and spaces will be saved, simplifying people lives.

### SUMMARY OF THE PRESENT INVENTION

An object of the present invention is to provide a USB multi-functional LED clip lamp for overcoming the above defects, wherein the multi-functional LED clip lamp is simple in structure, diverse, practical, safe, eco-friendly, and energy saving.

Accordingly, in order to accomplish the above object, the present invention provides:

a USB (universal serial bus) multi-functional LED (light emitting diode) clip lamp, comprising: a lightshade, an LED light source, a supporting column and a base, wherein the LED light source is mounted inside the lightshade; the supporting column has a rotatable structure; a top end of the supporting column is connected to the lightshade, and a bottom end of the supporting column is mounted on the base, in such a manner that the LED light source is adjustable by rotating the supporting column; a power plug is connected to the base for supplying the LED light source; wherein: the base comprises a clip for clamping, and a connecting box at a top of the clip, wherein a main control circuit board is arranged inside the connecting box, which comprises a USB module; wherein an interface module is fixed inside the connecting box, which comprises a USB interface for electrically connecting the USB module, and a power socket; wherein the USB interface and the power socket are both provided at an external surface of the connecting box; a switch for turning on or off the LED light source is also provided at the external surface of the connecting box; the main control circuit board is also electrically connected to an LED driving module for driving the LED light source, and the LED light source is electrically connected to the power plug through the LED driving module.

According to the present invention, the interface module combines the USB interface and the power socket, which is multi-functional, small and easy to be designed and configured. The main control circuit board combines the USB module and/or the LED driving module, which is multi-functional and is able to drive the LED light source and the USB interface. Furthermore, the main control circuit board is small and easy to be designed and configured.

Based on the above description, preferably, the supporting column is formed by a soft tube which is free to bend or rotate, wherein the soft tube is adjustable in all directions and is flexible for utilization. After being bent, a package volume is saved.

Based on the above description, preferably, the supporting column comprises a holder and a movable column, wherein the holder is mounted on a top face of the connecting box, a bottom portion of the movable column is mounted on the holder, a top portion of the movable column is connected to the lightshade through a movable joint which is rotatable in all directions, and a rotation shaft is arranged at a middle portion of the movable column.

Based on the above description, preferably, the LED driving module is arranged inside the connecting box and is mounted on the main control circuit board.

Based on the above description, preferably, the switch is a linear touching light adjuster, a springboard switch or a segmented touching switch.

Based on the above description, preferably, the LED driving module is arranged inside the power plug.

Based on the above description, preferably, the switch is a linear touching light adjuster, a springboard switch or a segmented touching switch.

Based on the above description, preferably, the USB driving module is electrically connected to the USB interface through an extending wire.

Based on the above description, preferably, the USB interface is welded on the main control circuit board.

Based on the above description, preferably, both the USB interface and the power socket are arranged at a side face or the top face of the connecting box.

Based on the above description, preferably, the USB interface comprises a single interface or double interfaces.

Beneficial effects of the present invention are as follows.

1) The present invention has a simple while reasonable structure, which is easy to use and is able to be fixed by directly fixing the clip at a table edge or other positions which is able to be clamped, and stability thereof is high. Furthermore, the interface module is directly fixed on the connecting box, so as to reduce developing costs of moulds, be easily assembled and reduce an overall volume. The main control circuit board needs a small space after being integrated.

2) The present invention is multi-functional, which combines functions of the LED lamp, the USB interface and the power socket. Furthermore, the structure is small, which saves resources as well as spaces, and is conducive to people daily lives and works.

3) Compared with conventional technologies, the LED light source is used, which requires a low input voltage, has a long life, and is more energy-saving as well as safer.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a preferred embodiment 1 of the present invention.

FIG. 2 is an exposed view of a main control circuit board and an interface module of the preferred embodiment 1 of the present invention.

FIG. 3 is a perspective view of a preferred embodiment 2 of the present invention.

FIG. 4 is an exposed view of the preferred embodiment 2 of the present invention.

FIG. 5 is a perspective view of a preferred embodiment 3 of the present invention.

FIG. 6 is an exposed view of the preferred embodiment 3 of the present invention.

Element reference: 1-clip, 2-connecting box, 3-lightshade, 4-soft tube, 5-USB interface, 6-power socket, 7-extending wire, 8-power plug, 9-springboard switch, 10-main control circuit board, 11-interface module, 12-linear touching light adjuster, 13-cover, 14-LED light source, 15-panel, 16-cooling fin, 17-lens, 18-movable column, 19-holder.

### DETAILED DESCRIPTION OF THE PREFERRED EMBODIMENT

Referring to drawings and preferred embodiments, the present invention is further illustrated.

### Preferred Embodiment 1

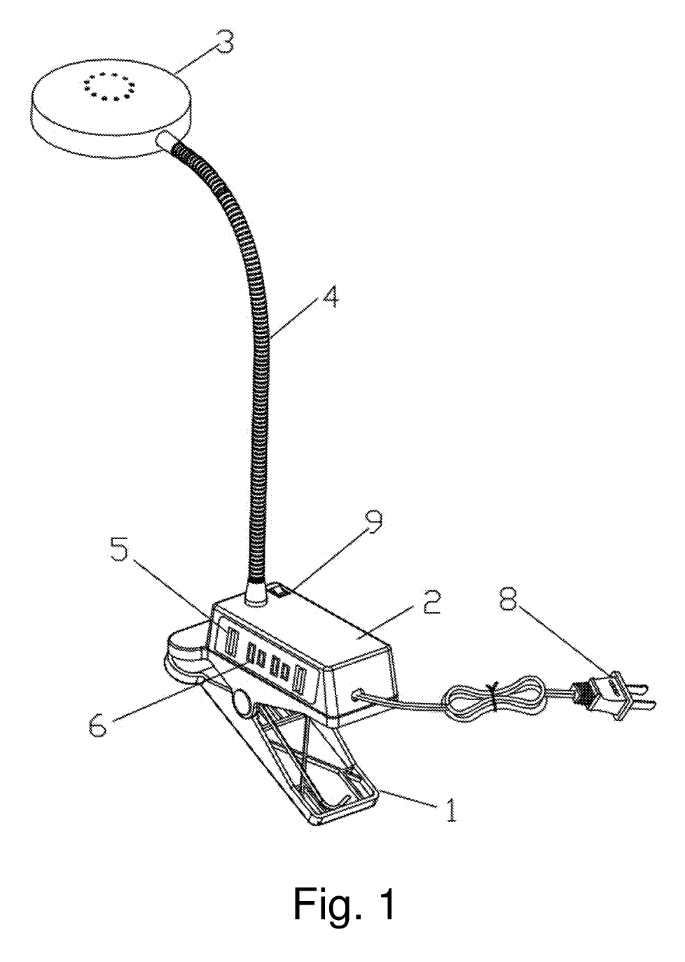

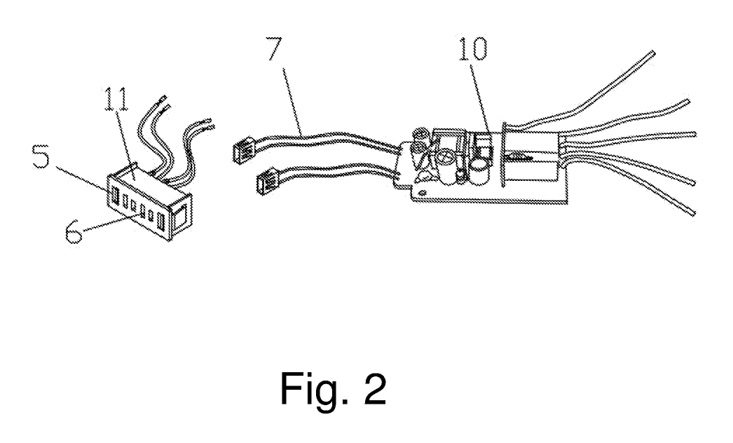

Referring to FIGS. 1 and 2 of the drawings, A USB (universal serial bus) multi-functional LED (light emitting diode) clip lamp according to the preferred embodiment 1 comprises: a lightshade 3, an LED light source 14, a supporting column and a holder, wherein the LED light source 14 is mounted inside the lightshade 3, and the supporting column has a rotatable structure. According to the preferred embodiment 1, the supporting column is formed by a soft tube 4 which is free to bend or rotate, wherein a top end of the soft tube 4 is connected to the lightshade 3, and a bottom end of the soft tube 4 is mounted on the base, in such a manner that the LED light source 14 is adjustable by rotating the soft tube 4.

A power plug 8 is connected to the base for supplying the LED light source 14; wherein: the base comprises a clip 1 for clamping and a connecting box 2 at a top of the clip 1, wherein a main control circuit board 10 is arranged inside the connecting box 2, which comprises a USB module; an interface module 11 is fixed inside the connecting box 2. Referring to the FIG. 2, the interface module 11 comprises a USB interface 5 for electrically connecting the USB module, and a power socket 6; wherein the USB driving module is electrically connected to the USB interface 5 through an extending wire 7, so as to be directly inserted into the interface module 11 through an corresponding interface for being connected; the USB interface 5 and the power socket 6 are both provided at a side face of the connecting box 2; a switch for turning on or off the LED light source 14 is also provided at the external surface of the connecting box 2, which the switch is a springboard switch 9 and is mounted on a top face of the connecting box 2; the main control circuit board 10 is also electrically connected to an LED driving module for driving the LED light source 14, the LED driving module is arranged inside the connecting box 2 and is mounted on the main control circuit board 10; the LED light source 14 is electrically connected to the power plug 8 through the LED driving module.

### Preferred Embodiment 2

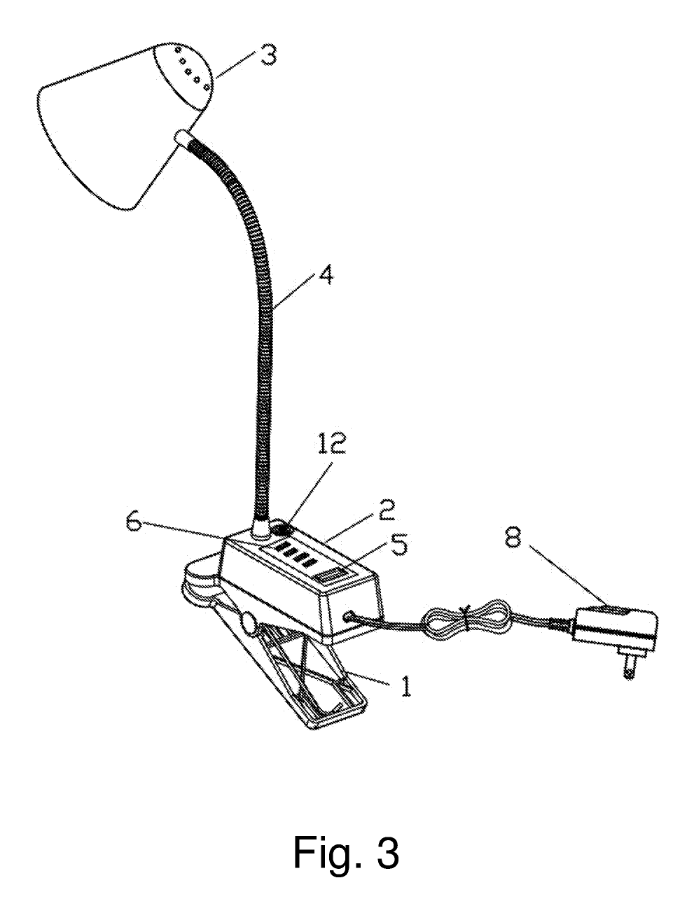

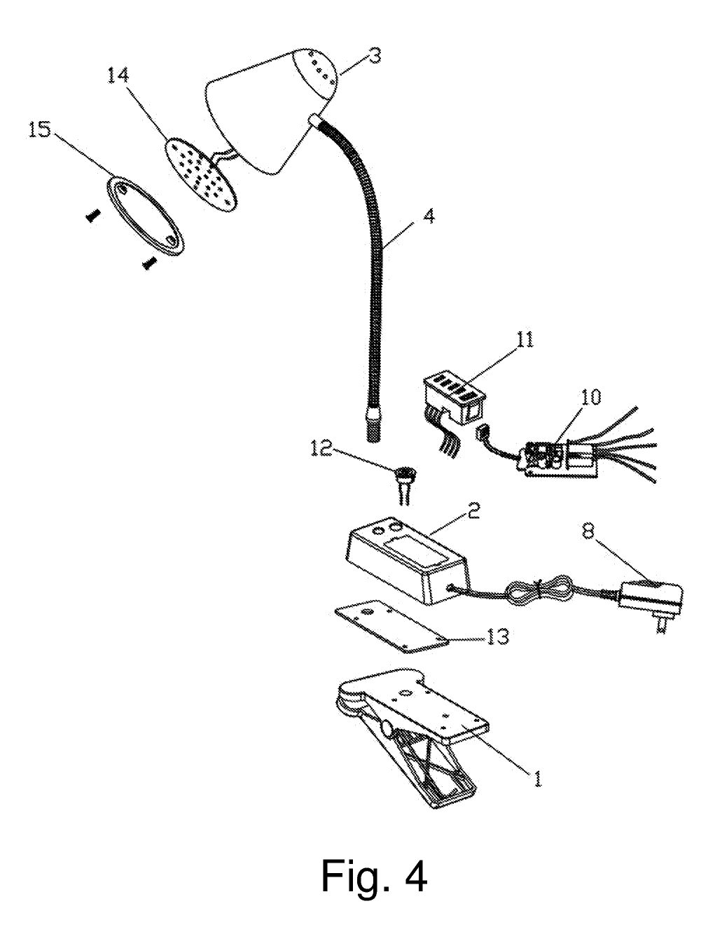

According to the preferred embodiment 2 and referring to FIGS. 3 and 4, different from the preferred embodiment 1, the LED driving module is arranged inside the power plug 8, for decreasing a volume of the connecting box 2. Referring to the drawings, when LED driving module is arranged inside the power plug 8, the power socket 6 is not able to directly output a high voltage. Therefore, for outputting the high voltage through the power socket 6, the LED driving module needs to be placed inside the connecting box 2 for outputting both the high voltage and a low voltage. Meanwhile, a linear touching light adjuster 12 is used for freely adjusting light by touching. In addition, according to the preferred embodiment 2, the USB interface 5 and the power socket 6 are both provided at a top face of the connecting box 2. A cover 13 is provided at a bottom of the connecting box 2, the lightshade 3 has a detachable structure, and a front end of the lightshade 3 comprises a penal 15.

### Preferred Embodiment 3

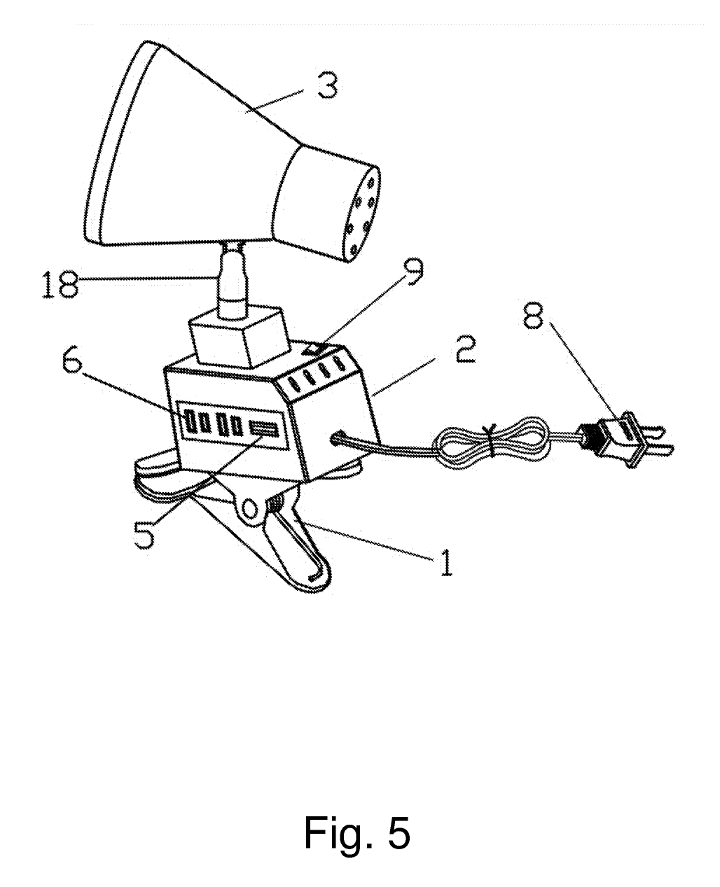

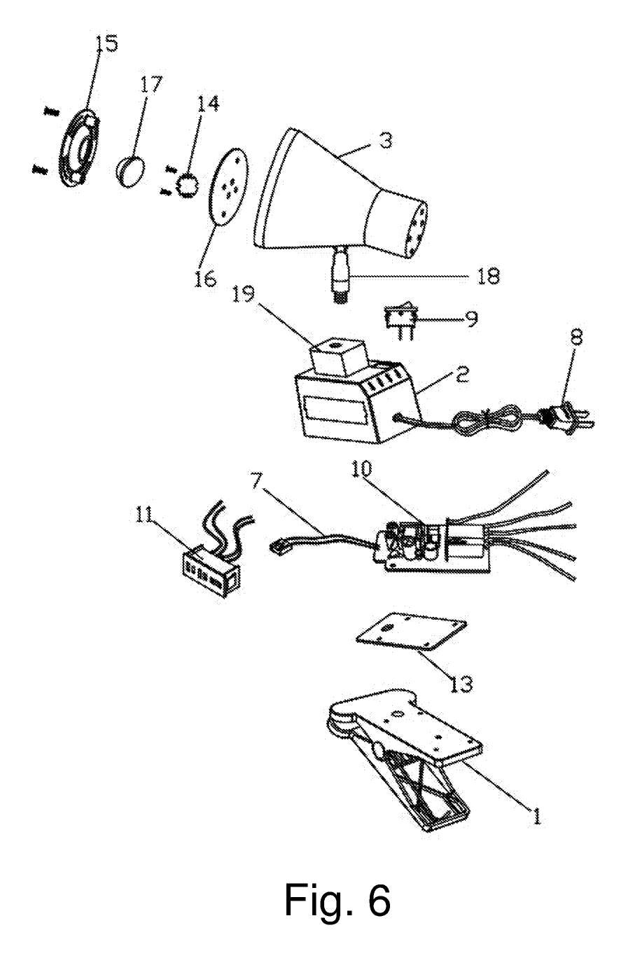

According to the preferred embodiment 3 and referring to FIGS. 5 and 6, different from the preferred embodiment 1, the supporting column comprises a holder 19 and a movable column 18, wherein the holder 19 is mounted on a top face of the connecting box 2, a bottom portion of the movable column 18 is mounted on the holder 19 through screws, a top portion of the movable column 18 is connected to the lightshade 3 through a movable joint which is rotatable in all directions, and a rotation shaft is arranged at a middle portion of the movable column 18. According to the preferred embodiment 3, the USB interface 5 and the power socket 6 are both provided at a top face of the connecting box 2. A cover 13 is provided at a bottom of the connecting box 2, the lightshade 3 has a detachable structure, and the LED light source 14 comprises a lens 7 and a cooling fin 16.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A USB (universal serial bus) multi-functional LED (light emitting diode) clip lamp, comprising: a lightshade, an LED light source, a supporting column and a base, wherein the LED light source is mounted inside the lightshade; the supporting column has a rotatable structure; a top end of the supporting column is connected to the lightshade, and a bottom end of the supporting column is mounted on the base, in such a manner that the LED light source is adjustable by rotating the supporting column; a power plug is connected to the base for supplying the LED light source; wherein: the base comprises a clip for clamping, and a connecting box at a top of the clip, wherein a main control circuit board is arranged inside the connecting box, which comprises a USB module; wherein an interface module is fixed inside the connecting box, which comprises a USB interface for electrically connecting the USB module, and a power socket; wherein the USB interface and the power socket are both provided at an external surface of the connecting box; a switch for turning on or off the LED light source is also provided at the external surface of the connecting box; the main control circuit board is also electrically connected to an LED driving module for driving the LED light source, and the LED light source is electrically connected to the power plug through the LED driving module.

2. The USB multi-functional LED clip lamp, as recited in claim 1, wherein the supporting column is formed by a soft tube which is free to bend or rotate.

3. The USB multi-functional LED clip lamp, as recited in claim 1, wherein the supporting column comprises a holder and a movable column, wherein the holder is mounted on a top face of the connecting box, a bottom portion of the movable column is mounted on the holder, a top portion of the movable column is connected to the lightshade through a movable joint which is rotatable in all directions, and a rotation shaft is arranged at a middle portion of the movable column.

4. The USB multi-functional LED clip lamp, as recited in claim 1, wherein the LED driving module is arranged inside the connecting box and is mounted on the main control circuit board.

5. The USB multi-functional LED clip lamp, as recited in claim 2, wherein the LED driving module is arranged inside the connecting box and is mounted on the main control circuit board.

6. The USB multi-functional LED clip lamp, as recited in claim 3, wherein the LED driving module is arranged inside the connecting box and is mounted on the main control circuit board.

7. The USB multi-functional LED clip lamp, as recited in claim 4, wherein the switch is a linear touching light adjuster, a springboard switch or a segmented touching switch.

8. The USB multi-functional LED clip lamp, as recited in claim 5, wherein the switch is a linear touching light adjuster, a springboard switch or a segmented touching switch.

9. The USB multi-functional LED clip lamp, as recited in claim 6, wherein the switch is a linear touching light adjuster, a springboard switch or a segmented touching switch.

10. The USB multi-functional LED clip lamp, as recited in claim 1, wherein the LED driving module is arranged inside the power plug.

11. The USB multi-functional LED clip lamp, as recited in claim 2, wherein the LED driving module is arranged inside the power plug.

12. The USB multi-functional LED clip lamp, as recited in claim 3, wherein the LED driving module is arranged inside the power plug.

13. The USB multi-functional LED clip lamp, as recited in claim 10, wherein the switch is a linear touching light adjuster, a springboard switch or a segmented touching switch.

14. The USB multi-functional LED clip lamp, as recited in claim 11, wherein the switch is a linear touching light adjuster, a springboard switch or a segmented touching switch.

15. The USB multi-functional LED clip lamp, as recited in claim 12, wherein the switch is a linear touching light adjuster, a springboard switch or a segmented touching switch.

16. The USB multi-functional LED clip lamp, as recited in claim 1, wherein the USB driving module is electrically connected to the USB interface through an extending wire.

17. The USB multi-functional LED clip lamp, as recited in claim 2, wherein the USB driving module is electrically connected to the USB interface through an extending wire.

18. The USB multi-functional LED clip lamp, as recited in claim 1, wherein the USB interface is welded on the main control circuit board.

19. The USB multi-functional LED clip lamp, as recited in claim 2, wherein the USB interface is welded on the main control circuit board.

20. The USB multi-functional LED clip lamp, as recited in claim 1, wherein both the USB interface and the power socket are arranged at a side face or a top face of the connecting box.
